(19) United States
(12) Patent Application Publication
(10) Pub. No.: US 2025/0147729 A1
(43) Pub. Date: May 8, 2025

(54) DEVICE AND METHOD FOR IDENTIFYING A SYNCHRONICITY RANGE OF TWO TIME SERIES OF RANDOM NUMBERS, AND USE

(71) Applicant: Wyrd Experience Ltd, Skipton (GB)

(72) Inventor: Wolfhardt JANU, Wolfsgraben (AT)

(73) Assignee: Wyrd Experience Ltd, Skipton (GB)

(21) Appl. No.: 18/726,129

(22) PCT Filed: Nov. 13, 2022
(86) PCT No.: PCT/EP2022/081691

§ 371 Date: Jul. 2, 2024

(30) Foreign Application Priority Data
Jan. 6, 2022 (DE) 10 2022 000 242.6

(51) Int. Cl. G06F 7/58

(52) U.S. Cl. CPC G06F 7/58

(57) ABSTRACT

Apparatus and method for identifying a synchronicity range of two time series of random numbers and use thereof The invention relates to a device for identifying at least one synchronicity range (SB) of two time series of random numbers, a first time series ((Aₖ)) and a second time series ((Bₖ)). The device comprises
a first non-deterministic random number generator (RNG1), preferably a quantum mechanical random number generator, for generating and providing a first bitstream block (St1),
a second non-deterministic random number generator (RNG2), preferably a quantum mechanical random number generator, for generating and providing a second bitstream block (St2), —a first computing device (G1) designed for calculating a first random number (Aₖ) from the bitstream block (St1) provided by the first random number generator (RNG1) and for generating a first time series ((Aₖ)) of random numbers by repeated calculation of first random numbers (Aₖ) from repeatedly provided first bitstream blocks (St1), and
a second computing device (G2) designed for calculating a second random number (Bₖ) from the bitstream block (St2) provided by the second random number generator (RNG2) and for generating a second time series ((Bₖ)) of random numbers by repeated calculation of second random numbers (Bₖ) from repeatedly provided second bitstream blocks (St2). The device is characterized in that it additionally comprises a detection unit (D) for detecting a synchronicity range (SB) within the two time series. The detection unit (D) is designed to determine a starting point (j) so that the reduced first and second time series ((A_{k>=j}), (B_{k>=j})) starting at this starting point exceeds a significance limit with respect to a correlation measure (z1, z2, z3, z4) in a range (k₁, k₂), k₁, k₂>=j, k₁<k₂.

The invention relates to a device and a method for identifying a synchronicity range of two time series of random numbers and uses of this method.

A random number generator is a method that generates a sequence of random numbers. The range from which the random numbers are generated depends on the specific random number generator. A distinction is made between non-deterministic and deterministic random number generators. A deterministic random number generator always produces the same sequence of numbers under the same initial conditions. A random number generator is non-deterministic if it delivers different values even under the same initial conditions. As the implementation of a software procedure usually works deterministically, an external, for example physical, process must be included to realize a non-deterministic random number generator. Non-deterministic random number generators that generate random numbers on a quantum mechanical basis are known. Binary numbers, i.e. either the value 0 or the value 1, are generated continuously. Random numbers are required for various statistical methods, among other things. Typical areas of application are computer games and cryptography methods.

The generated numbers can be checked using statistical tests. For example, the generated distribution (e.g. normal distribution, uniform distribution, exponential distribution, etc.) or the independence of consecutive numbers can be tested. The quality of a random number generator determines how well the generated numbers correspond to the statistical specifications. A very simple quality criterion is the period length, which should be as long as possible in relation to the range of values.

It can happen that a generator performs very well in several tests but fails in another. Particularly strict requirements are placed on cryptographically secure random number generators.

WO 2016 175 776 A1 shows a method for determining correlations and trends between two data sets. The claimed method provides for the provision of two independent data sets, such as the time series of parameters of an electronic device. The data sets can be suitably scaled for analysis and their temporal alignment can be corrected. The method involves examining the data sets for common trends and determining the degree of correlation between them. Methods such as the Pearson correlation coefficient or Brownian covariance are used to calculate the correlation.

US 2018 039 485 A1 discloses a device showing a synchronized non-deterministic random number generator and, in another embodiment, a plurality of spatially spaced independent random number generators. Also disclosed is a GPS receiver for providing time stamps and time synchronicity.

US 2006 167 825 A1 discloses a method and a system for detecting correlations between two time-based data streams. The method marks change points in the data streams, compares data streams with one another and groups together data streams with similar properties of change points.

CN 11 185 86 99 A discloses a method for determining correlations between two time series. The two time series are processed by smoothing and by means of “sliding windows”, i.e. time-shifted translation, in order to determine the degree of correlation.

In addition, US 2019 325 319 A1 shows a device and the associated method for automatically processing time series from multiple sources and checking them for correlations. For each pair of time series, a correlation can be checked using different statistical methods, so that an index value is output which indicates the degree of correlation.

The invention is based on the task of creating a device and an associated method which make it possible to recognize correlations or similar structures or synchronisms between the two time series of random numbers generated by a pair of non-deterministic random number generators in an improved manner.

Starting from a device for generating two time series of non-deterministic random numbers, a first and a second time series, comprising a first and a second non-deterministic random number generator, preferably quantum mechanical random number generators, which generate a random data stream from at least one physical noise source, for generating and providing a first and a second bitstream block, respectively, and a first and a second computing device designed for calculating a first and a second random number, respectively, from the bitstream block provided by the first and the second random number generator and for generating a first and a second time series of random numbers, respectively, by repeatedly calculating first and second random numbers, respectively, from the bitstream block provided by the first and the second random number generator and for generating a first and a second time series of random numbers respectively by repeatedly calculating first and second random numbers respectively from repeatedly provided first and second bitstream blocks respectively, the task set is solved in that the device additionally comprises a detection unit for detecting a synchronicity range within the two time series. The detection unit is designed to determine a starting point so that the reduced first and second time series starting at this starting point j exceeds a significance limit with respect to a correlation measure in a range (k₁, k₂), k₁, k₂>=j, k₁<k₂.

The problem is therefore solved by a device with the features of claim 1.

A quantum mechanical random number generator is a random number generator that uses quantum mechanical processes to generate randoms.

A synchronicity range is a range of increased order. A correlation measure is a measure of the significance of events. In a synchronicity range, the correlation measure exceeds the significance limit. If the correlation measure exceeds the value of 1.92, for example, this is referred to as a significant event.

The first and second random number generators are not coupled with each other. This means that the two random number generators generate random numbers independently of each other. This means that there is no causal relationship between the two generators when generating the random numbers.

The bitstream blocks provided by the two non-deterministic random number generators can also be read out by the same computing device, which then generates both the first and the second time series. This means that in one possible embodiment, the first computing device and the second computing device can be identical.

The first and second random number generators generate binary random numbers. This means that the random numbers can assume exactly two different values, for example the values 0 or 1. The generation of binary random numbers by the random number generators corresponds to ideal coin tosses. This means that the values 0 and 1 are each generated with a probability of 50%. The first and second time series generated by the random number generators satisfy a binomial distribution. With a generation of infinite time series, the binomial distribution tends towards a normal distribution.

If the detection unit does not find a starting point for which the reduced first and second time series starting at this starting point exceeds a significance limit with respect to a correlation measure in a range, it is verified that the two time series have no correlations with respect to the measure used.

Advantageous embodiments and further developments result from the dependent claims.

The detection unit can also be designed to determine a correlation density for a synchronicity range. The correlation density describes the synchronicity between the first and second time series in the synchronicity range. Various correlation measures are combined to determine the correlation density.

In a further development, the device comprises several pairs of random number generators, wherein the device is designed such that two time series of random numbers are generated for each pair and the detection unit is designed to determine synchronicity ranges and correlation measures for each pair of time series.

The device may additionally have at least one GPS sensor. The at least one GPS sensor is intended to localize the pairs of non-deterministic random number generators. In particular, the at least one GPS sensor is intended to determine the position of the individual pairs in relation to each other for a network of pairs of random number generators. The GPS sensor can be used to create a map in which the individual pairs of random number generators are localized. This can be a map of a hotel, a residential area or a natural area such as a meadow or a forest, for example. The correlation density can be visualized for each pair on the map. For example, contour lines of correlation densities can also be displayed on the map.

The detection unit can also be designed to determine intersections of synchronicity ranges between the pairs of random number generators. Intersections of two pairs of random number generators can be determined. However, intersections of three or more pairs of random number generators can also be determined. In the intersection, all pairs used for the intersection exceed the significance limit with respect to the correlation measure used. The intersection therefore represents a range of increased order for all pairs used.

The device can also have a clock generator. The clock generator causes the first and second non-deterministic random number generators to generate the first and second bitstream blocks at fixed clocks and to provide them to the first and second computing devices, which generate the first and second random numbers from them. The clock generator generates a time stamp for each clock pulse. The time stamp is saved with the first and second random numbers. In this way, the synchronicity of the two random number generators is further improved, as the first and second bitstream blocks are generated by the first and second random number generators at identical time intervals, which are defined by the time stamp. The clock generator can be controlled by an internal clock. The clock generator can also determine the clocks and time stamps by means of the GPS receiver from the GPS time transmitted in GPS messages. In a further embodiment, the device can additionally comprise a display unit. The display unit indicates whether the device is in a synchronicity range.

The display can vary depending on the magnitude of the specific correlation measure or the specific correlation density in the synchronicity range. For example, the display unit can be designed as a visual or an acoustic display unit. For example, the visual unit can display colors of a first color spectrum when the device is in a synchronicity range. And it can display colors of a second color spectrum when the device is outside a synchronicity range. According to the degree of synchronicity detected, the displayed color can vary within the selected color spectrum. Alternatively, the intensity of a color can be varied according to the degree of synchronicity detected.

Based on a method with the steps
Repeatedly generating and providing a first bitstream block by means of a first non-deterministic random number generator, preferably a quantum mechanical random number generator,
Repeatedly generating and providing a second bitstream block by means of a second non-deterministic random number generator, preferably a quantum mechanical random number generator,
Repeatedly calculating a first random number from the first bitstream block provided,
Repeatedly calculating a second random number from the second bitstream block provided,
Generating a first time series of random numbers from the repeatedly calculated first random numbers,
Generating a second time series of random numbers from the repeatedly calculated second random numbers,
the problem is solved in that the method additionally comprises the following step for identifying at least one synchronicity range
Detection of a synchronicity range within the two time series if a starting point can be determined so that the reduced first and second time series starting at the starting point j exceeds a significance limit with respect to a correlation measure in a range (k₁, k₂), k₁, k₂>=j, k₁<k₂.

The problem is therefore also solved by a method with the features of claim 9.

In one possible embodiment of the method, the correlation measure is calculated based on random walks. The calculation is based on the reduced first and second time series starting at the starting point j. The time series are prepared as random walks, i.e. the kth random number is assigned the sum of the random numbers from the time series up to the kth random number minus the expected value. In the case of a binary series of generated random numbers, i.e. with values 0 or 1, which correspond to an ideal coin toss, the expected value for a series with 1,000 values would be 500, for example, as the values 0 or 1 occur with the same probability. The use of random walks causes a memory effect. Each value in the time series remains included in future random numbers due to the summation of the random walk. If a deviation occurs, it remains included in future random numbers by the summation. If deviations occur one after the other, they add up to a larger total deviation.

In a further development of this embodiment, the correlation measure is calculated based on Fourier-transformed random walks of the reduced first and second time series starting at the starting point.

The method can also be generalized in such a way that the two time series can be shifted against each other to detect a synchronicity range. A separate starting point is determined for each of the two time series. The method calculates whether the correlation measure with respect to the shortened time series shifted against each other exceeds a significance limit. The method designed in this way detects repeating patterns in particular.

In another embodiment of the method, the correlation measure can be calculated based on a linear correlation coefficient of the reduced first and second time series starting at the starting point. This implementation has no memory effects, as no random walks are used. Only the linear correlation coefficient is determined using linear regression and the correlation measure is calculated from this.

In a further embodiment, the correlation measure can be calculated based on the entropy of the information of the reduced first and second time series starting at the starting point.

The various implementations of the method mentioned above can also be carried out in parallel in so-called channels. In each channel, a separate method is carried out based on a separate rule for calculating the correlation measure. A correlation density can be determined from the correlation measures calculated in parallel in the different channels by using the Stouffer method and/or the covariance. If the methods implemented in the different channels are independent of each other, the correlation density can be determined by using the Stouffer method. If channels are dependent on each other, the Stouffer method cannot be used; instead, the covariance of the processes must be determined. Different starting points and different synchronicity ranges can be determined for different channels. The different methods can therefore detect different order structures in the time series. Each channel is specialized in one type of anomaly. The correlation density is a superposition of the correlation measures of the different channels. If several channels show significant results at the same time, the correlation density is greater than the largest correlation measure of a single channel. If only one channel is significant, the correlation density is smaller than the correlation measure of this one channel. This results, for example, from the Stouffer method.

The calculation of the correlation density can take into account implementations of the method with memory effect and implementations of the method without memory effect.

In addition, a noise correction can be applied when calculating the correlation density.

According to another embodiment, the method is carried out for several pairs of random number generators. Two time series of random numbers are generated for each pair of random number generators and synchronicity ranges and correlation measures are determined for each pair of time series.

According to a further embodiment example, the generating the first and second random numbers in the method is triggered by a clock generator. The clock generator causes the first and second non-deterministic random number generators to generate the first and second bitstream blocks, from which the first and second random numbers are generated, at clock pulses determined by the clock generator. The clock generator generates a timestamp for each clock pulse. The associated time stamp is saved in the time series for each first and second random number.

The method according to the invention can be used to search for ordered structures in two or more time series.

The method according to the invention can also be used to determine interpersonal and/or chorological synchronicities.

The method according to the invention can also be used to verify the quality of the first and second random number generators. It can also be used to verify the independence of the first and second non-deterministic random number generators from each other in a time interval.

The method according to the invention can also be used to verify the suitability of the generated random numbers in a time interval for cryptographic purposes.

The method can be used, among other things, as a method for determining the current quality of the random number generators used. If at least one synchronicity range is identified, the currently generated random numbers correlate and could pose a security risk when used in cryptographic procedures.

The invention will now be explained by means of examples of embodiments with reference to the drawings.

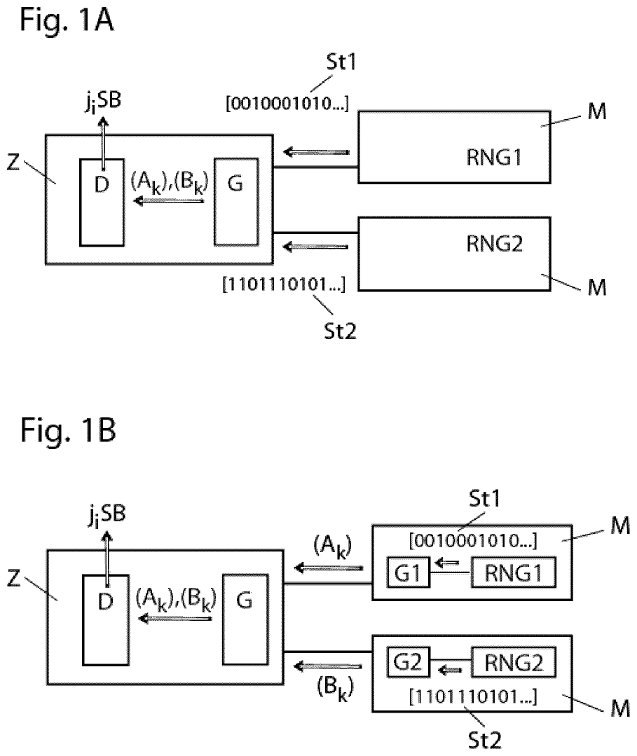

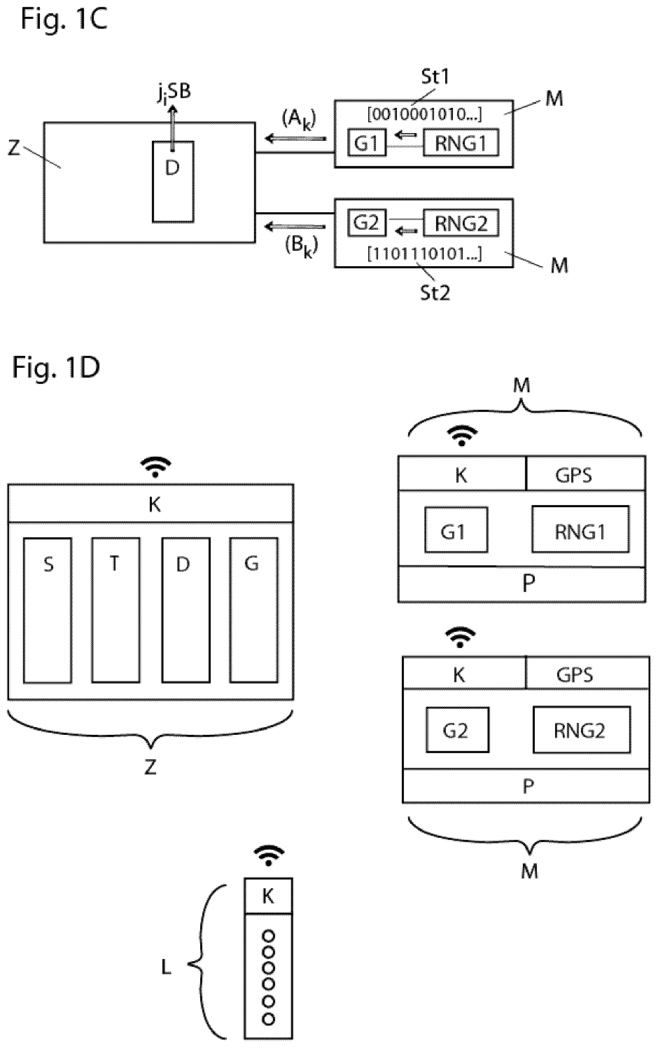

FIG. 1A shows a first device according to the invention

FIG. 1B shows a second device according to the invention

FIG. 1C shows a third device according to the invention

FIG. 1D shows a further development of a device according to the invention

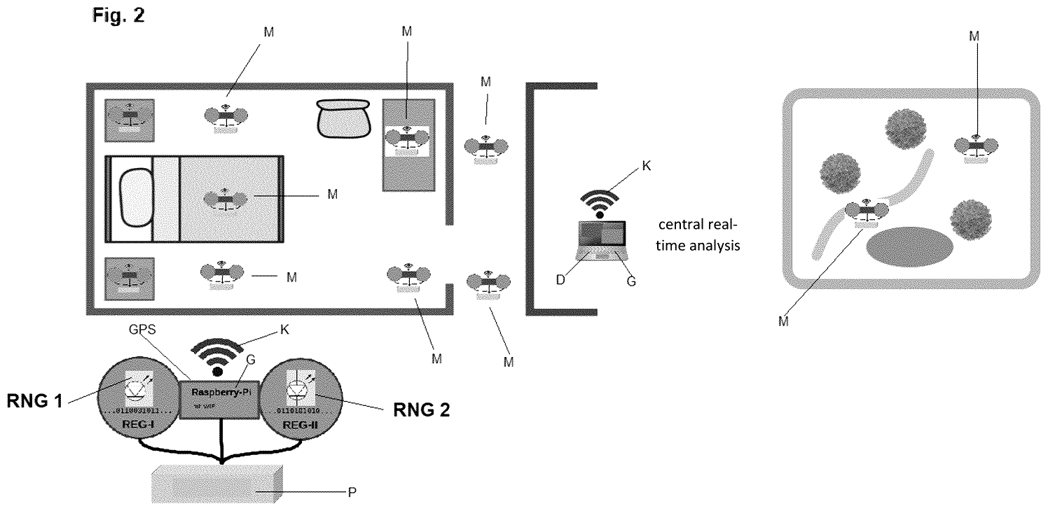

FIG. 2 shows an arrangement with several pairs of random number generators

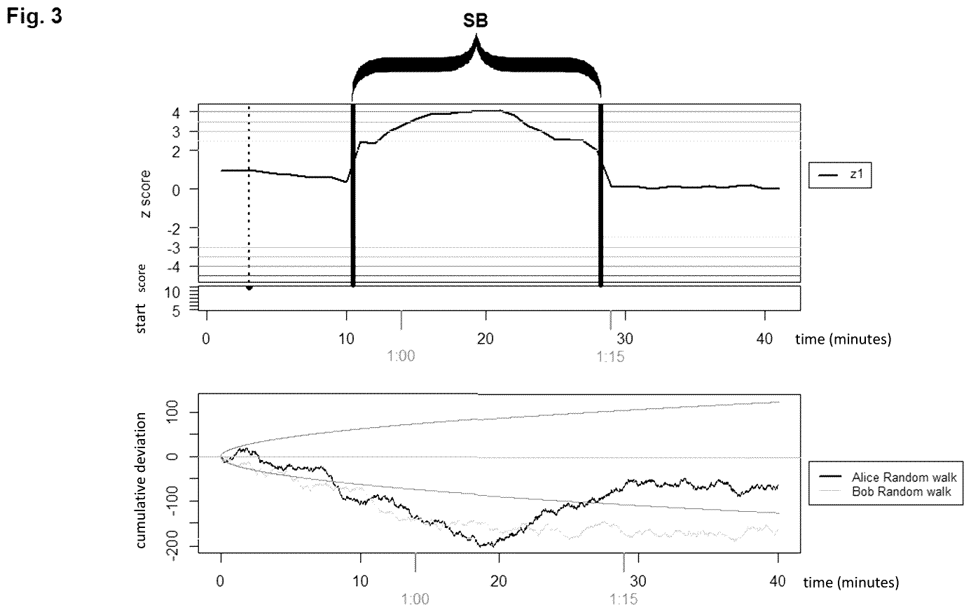

FIG. 3 shows the analysis of a first method according to the invention channel1

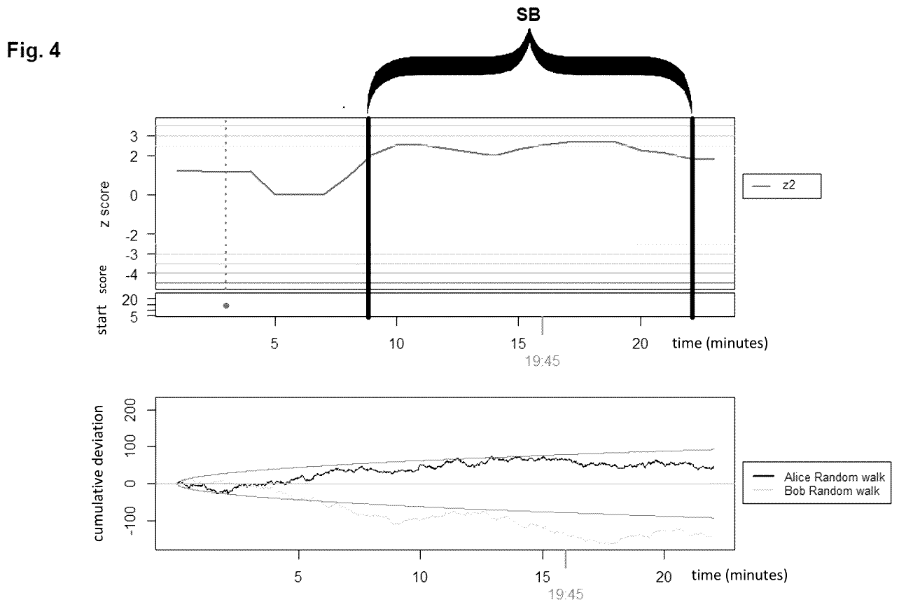

FIG. 4 shows the analysis of a second method according to the invention channel2

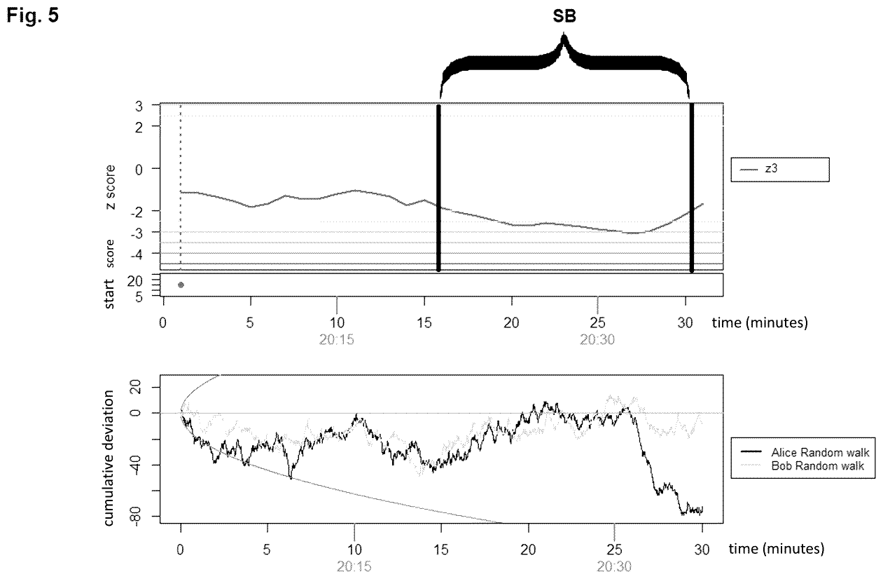

FIG. 5 shows the analysis of a third method according to the invention channel3

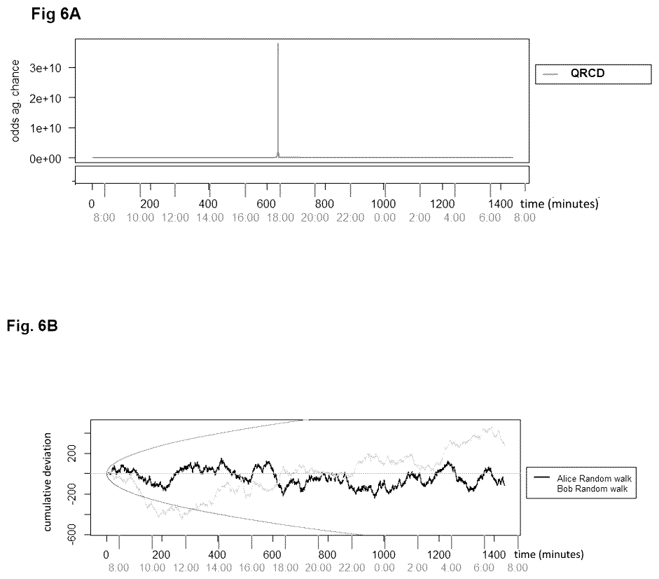

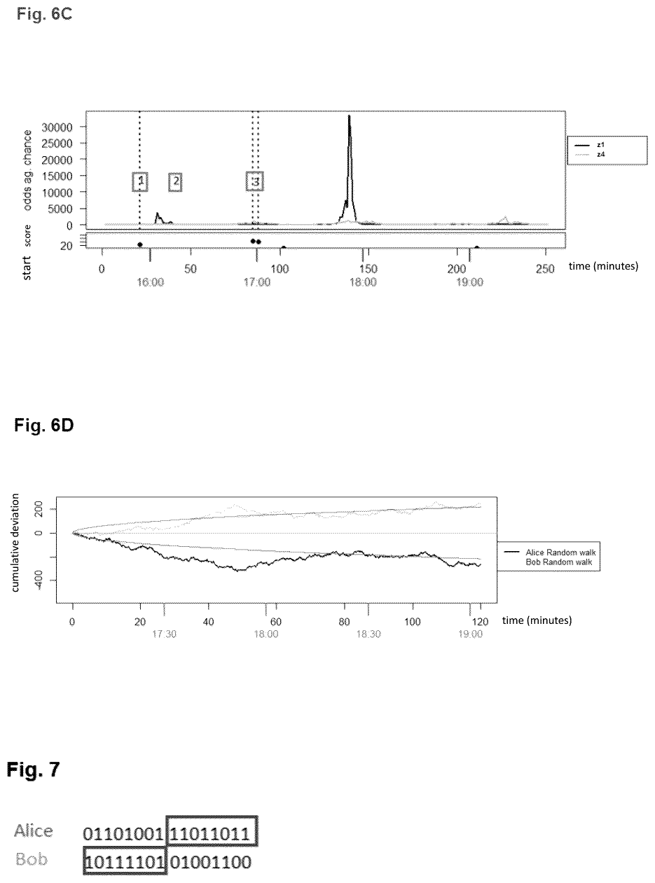

FIG. 6A shows a first summation curve

FIG. 6B shows an example of random walks of two random data series

FIG. 6C shows a second summation curve

FIG. 6D shows another example of random walks of two random data series

FIG. 7 shows an example of a memory effect

FIG. 1A shows a first device 1 according to the invention in a particularly simple embodiment. The device 1 comprises as first measuring unit M a first non-deterministic random number generator RNG1 and as second measuring unit M a second non-deterministic random number generator RNG2. Both random number generators use quantum mechanical processes to generate random numbers. For example, the quantum mechanical processes can be based on beam splitting or the tunnel effect. There are two possible events where the probability for each of the two possible events is exactly 50%. If the event occurs (e.g. tunneling through a barrier), a one is output, in the opposite case a zero. The distance between the two random number generators should be as small as possible. If possible, it should not exceed 50 cm. In one possible variant, both random number generators RNG1 and RNG2 can also be arranged on the same circuit board. Both random number generators RNG1, RNG2 are connected to the same central unit Z, which has a computing device G.

The random number generators RNG1, RNG2 each produce consecutive blocks of binary random numbers, so-called bit streams St1, St2. Both random number generators RNG1, RNG2 work with the same bit rate. For example, blocks can be generated every second. If the random number generators generate random numbers at a bit rate of 10 bit/s, then a block comprises ten binary numbers. Blocks of 10,000 bit/s, for example, can also be generated. The bitstream blocks St1, St2 are provided to the computing device G by the two random number generators RNG1, RNG2. The computing device G reads the bitstream blocks St1, St2 provided by the two random number generators RNG1, RNG2 at fixed time intervals, for example every second, and processes them further. The computing device G calculates a random number Aₖ, Bₖ from each of the first and second bitstream blocks St1, St2 in the kth time interval. For example, the random number can be calculated from the bit sum. For a bitstream St=0011010010, this would result in the random number 4. The random numbers Aₖ generated from the first bitstream blocks St1 of the first random number generator RNG1 form a first time series (Aₖ). The random numbers Bₖ generated from the second bitstream blocks St2 of the second random number generator RNG2 form a second time series (Bₖ). The time series of random numbers (Aₖ), (Bₖ) are provided to the detection unit D. This then detects synchronicity ranges SB within the two time series (Aₖ), (Bₖ).

In a second device 1 according to the invention, as shown in FIG. 1B, the first and second measuring units M each also comprise a first and second computing device G1, G2, respectively, which each perform a preprocessing of the bit streams St1, St2 supplied by the random number generators RNG1, RNG2. For example, the first or second computing device G1, G2 can calculate a random number (Aₖ), (Bₖ) from each of the bitstream blocks St1, St2 provided to them. Instead of transmitting the complete bitstream blocks St1, St2 to the central unit Z or making them available to the computing device G, which is part of the central unit Z, it is sufficient to transmit only the result of this pre-processing, for example the calculated random numbers Aₖ, Bₖ to the central unit Z or make them available to the computing device G by means of local pre-processing of the bitstream blocks St1, St2 directly in the respective measuring unit M.

FIG. 1C shows a third device 1 according to the invention, in which the entire processing of the bitstream blocks St1, St2 into time series of random numbers (Aₖ), (Bₖ) and, if necessary, their further processing takes place in the first or second local computing device G1, G2. The processed time series of random numbers (Aₖ), (Bₖ) are transmitted from the respective measuring device to the central unit Z. The detection unit D arranged in the central unit Z then detects synchronicity ranges SB within the two time series (Aₖ), (Bₖ).

Optional further developments of the device according to the invention are shown in FIG. 1D. Here, the central unit Z and the two measuring units M have communication units K to transmit data from the measuring units M to the central unit Z via the communication units K. The communication units K can be WLAN routers, for example. In addition, the device 1 can comprise a memory device S for saving the first and second time series (Aₖ), (Bₖ). Furthermore, the central unit Z or the two measuring units M can comprise a clock generator T, which causes the random number generators RNG1, RNG2 to generate the respective bitstream blocks St1, St2 synchronously at fixed clocks. A GPS sensor GPS can be arranged in each of the measuring units M. The two measuring units M can also use a common GPS sensor GPS. The measuring units can localize themselves via the GPS sensor GPS. In addition, the time stamps in the GPS messages received by the GPS sensor can be used to synchronize the measuring units with each other. A battery unit P supplies the respective measuring unit M with power. The battery unit P could also be designed as a solar cell. Due to the local power supply, the measuring unit can be positioned in hard-to-reach places over a long period of time and generate random numbers.

The device 1 can also include a display unit L to visualize synchronicity ranges SB. The display unit L can, for example, make synchronicity ranges SB perceptible in real time by means of optical and/or acoustic signals. Depending on the magnitude of the correlation measure z1, z2, z3, z4 used, the strength of the correlation can be made visible by a finer resolution of the optical and/or acoustic signals. For example, the finer resolution can be achieved by using different colors or an arrangement of LED elements, whereby more LED elements light up as the correlation increases, or by varying the frequencies of acoustic signals. The display unit L can also have a communication unit K, via which it can receive information on synchronicity ranges SB and on the magnitude of correlation measures z1, z2, z3, z4 from the central unit Z. FIG. 2 shows an arrangement with several measuring units M, each comprising pairs of random number generators RNG1, RNG2. In an area, for example a hotel area, several measuring units M are set up at different locations. The measuring units M are connected to a network or connected to a central computer Z. For example, measuring units M can be located in a hotel room, in the hallway, in the lobby or in the garden or surroundings of the hotel. The central computer Z can be located in the hotel area, for example in an adjoining room or in the hotel lobby.

The measuring units should be as miniaturized as possible in order to be able to install them easily and in a space-saving manner at the various locations. In addition to the two random number generators RNG1 and RNG2, the miniaturized measuring units M comprise a local computing device G, a GPS sensor GPS for localizing the measuring unit M, a local communication unit K and an autonomous power supply P via power bank or solar panel. They can also include a local clock generator for time synchronicity T. Ideally, all components of a measuring unit M are combined in one device on a common circuit board. Alternatively, however, the components can also be controlled by a local computing device G located on a mini-computer, such as the RaspberryPi, and supplied with energy via an external power bank P.

The local measuring units M are connected to a central communication unit K of the central computer Z via the local communication unit K, for example a WLAN router. Random number data, for example pairs of bitstream blocks St1, St2, or random number data processed by the local computing device G of the measuring unit M are transmitted to the central computer Z via the communication units K. The central computer Z has a central computing device G for generating random number time series from the random number data received from the measuring unit M and a detection unit D, which recognizes synchronicity ranges SB for each local measuring unit M and determines correlation densities QRCD. By determining correlation densities QRCD for several measuring units M in parallel, location-dependent correlation density profiles can be created, for example for the hotel area.

It is normally assumed that non-deterministic random processes in random number generators RNG1, RNG2, as in the devices shown in FIG. 1 and FIG. 2, run completely locally, i.e. independently of each other. In this case, no correlations are observed between two random processes. However, if two such processes produce synchronous data to a significant extent (e.g. produce more ones than zeros at the same time or produce zeros and ones at the same time), then these processes cannot be considered 100% separate from each other.

According to the laws of quantum physics, the result of quantum mechanical random processes is completely indeterminate, i.e. purely random. Consequently, there can be no cause-and-effect relationship between quantum mechanically generated random numbers. Synchronous sections in two time series of random numbers generated by two different quantum mechanical random number generators can therefore only be attributed to correlations. The significance of such correlations can also be understood as a measure of the dependence or non-locality of the random processes involved. Various correlation measures z1, z2, z3, z4 can be defined to calculate the significance of such correlations. The different correlation measures z1, z2, z3, z4 react to different order structures.

The method according to the invention searches synchronicity ranges SB in which such correlated, i.e. ordered, structures occur in pairs of time series. The synchronicity ranges SB are embedded in sections of random fluctuations.

A synchronicity range SB is assigned a correlation density QRCD (Quantum Random Correlation Density). The correlation density QRCD indicates the degree of order in a pair or between several pairs of quantum mechanically generated time series of random numbers ((Aₖ), (Bₖ)). The correlation density QRCD indicates and quantifies the frequency of synchronous events in a time interval. The correlation density QRCD is therefore a frequency density of correlating structures in a time interval. The correlation density QRCD is a real number that indicates the probability that the measured order between the data series did not occur by chance. The correlation density QRCD is given, for example, as a z-value (deviations from the expected value in multiples of the standard deviation) or as “odds against chance” (probability that the value did not occur by chance). The correlation density QRCD describes a density of ordered data structures generated by the superposition of different correlation measures z1, z2, z3, z4. Ordered structures are recognized by their respective characteristic features. Finding synchronicity ranges SB and calculating a correlation density QRCD as such can be applied to any time series problem.

In the following, methods for identifying at least one synchronicity range SB are presented in various embodiments. Each embodiment is characterized by an associated correlation measure z1, z2, z3, z4. Each embodiment is associated with a channel channel1, channel2, channel3, channel4 in which the respective method is performed.

First, specific methods channel1, channel2, channel3 with correlation measures z1, z2, z3 with memory effect are described. For these first groups of methods according to the invention, the random numbers of the two time series are prepared as random walks (one-dimensional random walks).

For this purpose, as shown in Formula 1, the sum of the random numbers generated up to a certain point in time, Zₖ, is formed for each time series and the expected value calculated for this point in time is subtracted.

$$Formula 1$$

$${Y}_{k} = {\sum }_{n = 0}^{k} {Z}_{n} - {μ}_{0} n ∈ {ℕ}_{0}$$

Then, instead of the original two time series of random numbers (Aₖ), (Bₖ), the summed data series prepared as random walks (RAₖ−Σₙ₌₀^{k} Aₙ−μ₀), (RBₖ=Σₙ₌₀^{k} Bₙ−μ₀) are considered.

When searching for synchronicity ranges, these random walks are considered for different starting points j and these reduced data series are analyzed (RA_{k>=j}=Σₙ₌ⱼ^{k} Aₙ−μ₀), (RB_{k>=j}=Σₙ₌ⱼ^{k} Bₙ−μ₀) are analyzed.

The following procedure is applied iteratively to the specific methods Channel1, Channel2, Channel3 with correlation measure z1, z2, z3 with memory effect described below:

If you want to determine the value for a data point with the highest possible order for a channel1, channel2, channel3 method at a specific time tₖ, all reduced data series (RA_{k>=j}), (RB_{k>=j}), must be included in the calculation for all possible starting points j<=k for this determination. Therefore, for each of these starting points j for the two reduced random walks (RA_{k>=j}), (RB_{k>=j}) series of correlation measures z1ⱼ, z2ⱼ, z3ⱼ are calculated according to the formulas 3-5 below, which measure the correlation between the two reduced random walks. Then, for each of these series of correlation measures z1ⱼ, z2ⱼ, z3ⱼ the value with the highest order zᵢⱼ, i=1, . . . , 3, is determined and assigned to the respective data point.

For each individual starting point j with starting time tⱼ, the two reduced random walks are first transformed so that the initial value of both data series is zero, and then the channel-specific correlation measure z1, z2, z3 is applied. The result of this process is a series of correlation measures (zᵢⱼ(RA_{j<=k}, RB_{j<=k})ⱼ) for starting points j and correlation measures zᵢ i=1, . . . , 3 belonging to a data point at time tₖ.

Either the data series of the random walks are used directly as output values or transformed data series are used, which are calculated e.g. by derivation, difference formation or Fourier transformation of the random walks.

Since this calculation for longer time series, in particular with more than 1,000 random numbers or time intervals of more than 1,000 discrete time points under consideration, the noise effect increases, it is not sufficient to consider the largest entry from this series of correlation measures for a data point at time tₖ as the result. This is because the noise of such a method increases the more starting points for a particular data point are included in the comparison. For a data point that is further back in a time series, i.e. with a large k, the series of correlation measures under consideration (zᵢⱼ (RA_{j<=k}, RB_{j<=k})ⱼ) has more series members that are included in the search for the largest value in this series than for a data point further forward, i.e. with a small k. The noise would therefore continue to increase as the length of the data series increases.

Therefore, the reciprocal values of the probabilities pᵢⱼ associated with the correlation measures zᵢⱼ are used instead and these are normalized over the length of the test duration from the respective starting point to the data point (see Formula 2). A series pᵢⱼ therefore contains the reciprocal values of the random probability assigned to each starting point for a channel i (i=1, . . . , 3). Each reciprocal value of this series is multiplied by the respective test duration and a constant. This constant can be 1. The test duration is the time between the data point and the respective starting point. The highest value of the resulting series of numbers is considered and selected for the respective method zᵢ as the value with the highest degree of order for the current data point. The selected value is then transformed back into the original correlation measure zⱼ and assigned to the data point k as the value with the highest possible order zₖ together with the associated starting point j. A data point k thus receives i (i=1, . . . , 3) assigned values of the highest possible order (zᵢₖ) together with i associated starting points t₀ᵢₖ.

This process is repeated iteratively for all data points of the two random walks.

The procedure described above always calculates starting points of maximum order ranges regardless of whether they are significant or not. The assigned correlation measures z1, z2, z3 can then be used to determine whether the assigned range is significant or not. The method assigns the maximum achievable degree of order to each point of the two data series using Formula 2.

The time intervals in which the reduced random walks of the two time series (A_{k>=j}), (B_{k>=j}) exceed a significance limit with respect to a correlation measure z1, z2, z3 at the starting point j are referred to as synchronicity ranges SB.

Since the choice of the starting point j determined in this way changes the test duration under consideration and thus also the index of the discrete time point associated with the data point, the following considerations are illustrated with the starting time t₀ and the time t for the data point instead of the starting time tⱼ and the time tₖ for the data point.

$$Formula 2$$

$$degree of order = \frac{c * T ( t - {t}_{0} )}{p ( T ( t - {t}_{0} ) )}$$

$$T ( t - {t}_{0} ) = T est duration between data point and starting point .$$

$$c constant ( can also be 1 )$$

$$p ( T ( t - {t}_{0} ) ) = probability that the data point at t with starting point {t}_{0} was created by chance$$

For a more compact representation,

instead of the discrete time series representation, the representation as a function of the time variable t is also shown below. The bit rate can be used to convert the discrete representation into this representation and vice versa. The two random number generators combined in one measuring unit are referred to as Alice and Bob in the following examples. Alice(t) and Bob(t) represent the values from the time series at time t. If Alice and Bob each generate bitstream blocks with e.g. 10 bits per second and the computing unit calculates exactly one random number Aₖ from each bitstream block from the respective bit sum, then the index k corresponds to the random number of time t multiplied by the bit rate.

FIG. 3 shows the analysis of a first method according to the invention channel1 based on the first correlation measure z₁. The calculation of the correlation measure z₁(t) from the values of the time series Alice(t) and Bob(t) is shown in Formula 3. The correlation measure z₁ at time t is then calculated from the mean value of the random walks R1, R2 of the two time series Alice(t) and Bob(t) divided by the common standard deviation at time t.

$$Formula 3$$

$${z}_{1} ( t ) = \frac{\vert y ( Alice ( t ) ) \vert + \vert y ( Bob ( t ) ) \vert}{\sqrt{2} \cdot σ ( Alice ( t ) )}$$

$$σ ( Alice ( t ) ) = σ ( Bob ( t ) ) = \sqrt{025 \cdot n}$$

$$T ( t - {t}_{0} ) = duration in seconds$$

$${t}_{0} = starting point$$

$$σ = standard deviation for T ( t - {t}_{0} )$$

$$y ( Device ( t ) ) = {\sum }_{k = {t}_{0} \cdot bits / s}^{k = t \cdot bits / s} {X}_{k} - {μ}_{0}$$

$${μ}_{0} = expected value = 0.5$$

$$n = number of bits in the interval T ( t - {t}_{0} )$$

In the upper graph in FIG. 3, the correlation [symbol] scaled in minute intervals (x-axis). The dotted line shows the starting point t₀, which is determined by the specified calculation from the correlation measure z₁ and the reduced time series. In the synchronicity range SB, the value z₁(t) is higher than the significance limit 1.92. The lower graph shows the associated random walks R1, R2 of the two time series Alice(t) and Bob(t) (y-axis). The parabolas show the significance limit of z=+/−1.92. The horizontal center line represents the mean value μ0=0. A synchronicity range SB detected by the method is marked.

FIG. 4 shows the analysis of a second method according to the invention channel2 based on the second correlation measure z₂. The calculation of the correlation measure z₂(t) from the values of the time series Alice(t) and Bob(t) results from formula 4. This method channel2 maps the greatest possible distance between the two random walks R1, R2. The calculation of the correlation measure z₂ is carried out using the binomial distribution.

$$Formula 4$$

$$\vert d ( t ) \vert = 2 \cdot \vert ( y ( Alice ( t ) ) - y ( Bob ( t ) ) \vert , \qquad ( 1 )$$

$$d ( t ) = distance at time t with starting point {t}_{0}$$

$$\vert d ( t ) \vert = \vert 2 {k}_{t} - n \vert \qquad ( 2 )$$

$$n = 2 \cdot T ( t - {t}_{0} ) \cdot \frac{bits}{s} , {k}_{t} = k at time t$$

$$p ( t ) = {\sum }_{k = {k}_{t}}^{k = n} ( \begin{matrix}n \\ k\end{matrix} ) \cdot {( 0.5 )}^{n} \qquad ( 3 )$$

$$p ( t ) = probability to find at time t the distance d ( t )$$

In the upper graph in FIG. 4, the correlation measure z₂(t) (y-axis) is plotted against a time axis scaled in minute intervals (x-axis). The dotted line shows the starting point t₀, which is determined by the calculation below from the correlation measure z₂ and the reduced time series. In the synchronicity range SB, the value z₂(t) is greater than the significance threshold 1.92. The lower graph shows the associated random walks R1, R2 of the two time series Alice(t) and Bob(t) (y-axis). The parabolas show the significance limit of z=+/−1.92. The horizontal center line represents the mean value μ0=0. A synchronicity range SB detected by the method is marked.

FIG. 5 shows the analysis of a third method according to the invention channel3 based on the third correlation measure z₃. The calculation of the correlation measure z₃(t) from the values of the time series Alice(t) and Bob(t) results from formula 5. This method channel3 maps the smallest or largest possible average distance between the two random walks R1, R2.

$$Formula 4$$

$$f ( x ) = \{ \begin{matrix}\frac{{b}^{p}}{Γ ( p )} {x}^{p - 1} {e}^{- bx} & x > 0 \\ 0 & x \leq 0\end{matrix}$$

$$x = average distance at t in T ( t - {t}_{0} )$$

$$approximation smallest possible average distance :$$

$$b = \frac{1}{0.034 \cdot \sqrt{T ( t - {t}_{0} )}} , p = 18.7$$

$$approximation highest possible average distance :$$

$$b = \frac{1}{0 \text{.347} \cdot \sqrt{T ( t - {t}_{0} )}} , p = 3.4$$

$$z = \frac{P ( p , b x ) - μ}{σ} ,$$

$$μ = \frac{p}{b} ,$$

$$σ = \sqrt{\frac{p}{{b}^{2}}} ,$$

$$P ( p , bx ) = probability to find x at time t in T ( t - {t}_{0} )$$

In the upper graph of FIG. 5, the correlation measure z₃(t) (y-axis) is plotted against a time axis scaled in minute intervals (x-axis). The dotted line shows the starting point t₀, which is determined by the calculation below from the correlation measure z₃ and the reduced time series. In the synchronicity range SB, the value z₃ (t) is greater than the significance threshold 1.92. The lower graph shows the associated random walks R1, R2 of the two time series Alice(t) and Bob(t) (y-axis). The parabolas show the significance limit of z=+/−1.92. The horizontal center line represents the mean value μ0=0. A synchronicity range SB detected by the method is marked.

A method without memory effect channel4 is described below. For this method, the random numbers of the time series cannot be processed as random walks. Instead, the time series of the random numbers are analyzed directly in this Channel4 method. In this case, the linear regression coefficient r can be used to calculate correlations.

$$Formel 6$$

$${z}_{4} = r \sqrt{\frac{( T ( {t}_{E} - t ) - 2 )}{( 1 - {r}^{2} )}}$$

$$T ( {t}_{E} - t ) = interval with start point t and end point {t}_{E}$$

Using the correlation coefficient r, the method searches for the longest possible sections on which the correlation measure z₄ assumes large values. Since only correlations at the same point in time or with a well-defined time offset are considered, data points that cannot be clearly assigned to a common time stamp are discarded. Because there is no memory effect here, the overall result is highly dependent on the accuracy of this step and the synchronicity of the time stamps of the two time series. Sufficient data points (n>=50) must be used for a significant calculation of r. The Channel4 method assigns a unique maximum z₄ value to each time point, which reflects the degree of order for this method.

The noise for a channel1, channel2, channel3, channel4 method is determined as follows:
Any two random data series are generated with a duration that corresponds to the test duration of the longest data series to be examined. Algorithms for random generation can also be used here (pseudo-random).
The Channel1, Channel2, Channel3, Channel4 method for determining the correlation measure z1, z2, z3, z4 is applied to these data series.
This process is repeated iteratively and the mean value is calculated from these repetitions until a significant mean value can be formed for the correlation measure under consideration for each point in time.
This results in an average correlation measure z1, z2, z3, z4 for each point in time, which is created by purely random fluctuations. This is the noise value.
This noise value is the actual expected value of the channel1, channel2, channel3, channel4 method at a specific point in time.

Noise correction is performed as follows:

The correlation measures z1, z2, z3, z4 of a method channel1, channel2, channel3, channel4 can be recalculated at all times using the actual expected values of the method (noise values). The recalculated correlation measures z1, z2, z3, z4 reflect the probability that they were not caused by the mere noise of the method.

It is now described how an associated correlation density QRCD to a local measurement unit M with a pair of random number generators RNG1, RNG2 can be determined from the combination of different embodiments by means of suitable mathematical operations. Mathematical operations can also be arithmetic operations such as subtraction or Fourier transformation, which are applied to one or both time series.

The Stouffer method can be used to calculate the correlation density QRCD for the first, second and fourth methods Channel1, Channel2, Channel4 or the first, third and fourth methods Channel1, Channel3, Channel4. The Stouffer method forms the sum of all independently determinable correlation measures zᵢ and divides this by the square root of the number of methods used. The second method, channel2, and the third method, channel 3, are not orthogonal and therefore cannot be combined with the Stouffer method. Therefore, either only one of the two methods Channel2, Channel3 is used to calculate the correlation density QRCD or, if the second and third methods Channel2, Channel3 are both to be included, then the covariance between these two methods must be calculated.

Memory effects can also be taken into account when calculating the correlation density QRCD. A memory effect occurs when ordered and unordered processes occur with a time delay in two random data series. An example is shown in FIG. 7. A first random number generator Alice initially generates a non-significant segment followed by a segment with significantly more ones than zeros, while a second random number generator Bob generates significantly more ones than zeros followed by a non-significant time segment. The greater the correspondence between the length of the two non-significant segments and the number of ones, the higher the correlation density QRCD.

One embodiment of the method according to the invention uses this method to detect interpersonal synchronicities. A further embodiment uses the method for detecting chorological synchronicities. Interpersonal synchronicities describe the occurrence of synchronicity areas for group-psychologically significant events or phases. Chorological synchronicities represent the (long-term) mean values of the degree of order, and thus the QRCD, of a location.

FIGS. 6A-6D illustrate an embodiment of the interpersonal synchronicity of the method according to the invention.

FIG. 6A shows the sum curve of an analysis of approx. 24 hours of random data from a self-awareness seminar.

FIG. 6B shows the associated random walks of the two random generators RNG1 and RNG2 as a cumulative deviation from the expected value. If only the random walks are considered, it is visually difficult to detect anomalies. At around 18 o'clock, the software finds a highly ordered data structure. The sum curve QRCD is composed of four different types of order, which are obtained by four different methods channel1, channel2, channel3, channel4 with four different correlation measures z1, z2, z3, z4. Only two of these are shown in the detailed view in FIG. 6C so that the smaller peak at approx. 15:45 can also be displayed well. The vertical dashed lines show the starting points of the following structure found by the analysis software, the small graph below shows the number of starting points found. The times marked “1”, “2” and “3” are the start times of group dynamic events that were documented during the measurement. The start of events “1” and “3” occurs together with the start of highly significant ordered structures.

FIG. 6C again shows the primary data of the random generators as in FIG. 6A. FIG. 6D shows the associated random walks from event “3”. The parabolas represent the significance limits. The high degree of order of the structure found is evident from the common structural features and the common breakthrough of the significance threshold. The joint occurrence of ordered structures and group dynamic events can be used, for example, as a measure of interpersonal synchronicities as a feedback method.

Chorological synchronicities can be used as a measure of the state of a local ecosystem. One possible application is the accompanying measurement during the renaturation of ecosystems as a further feedback method.

### LIST OF REFERENCE SYMBOLS

1 Device
Aₖ Random number
Bₖ Random number
(Aₖ) First time series
(Bₖ) Second time series
D Detection unit
G Computing device
G1 First computing device
G2 Second computing device
GPS GPS sensor
j Starting point
k₁ Lower range limit
k₂ Upper range limit
K Communication unit
Channel1 First method
Channel2 Second method
Channel3 Third method
Channel4 Fourth method
L Display unit
M Measuring unit
P Battery unit
QRCD Correlation density
R1 Random Walk of the first time series
R2 Random Walk of the second time series
S Memory device
SB Synchronicity range
St1 First bitstream block
St2 Second bitstream block
T Clock generator
RNG1 First non-deterministic random number generator
RNG2 Second non-deterministic random number generator
Z Central unit
z1 First correlation measure
z2 Second correlation measure
z3 Third correlation measure
z4 Fourth correlation measure

1. Device (1) for identifying at least one synchronicity range (SB) of two time series of random numbers, a first time series ((Aₖ)) and a second time series ((Bₖ)), comprising
a first non-deterministic random number generator (RNG1), preferably a quantum mechanical random number generator, for generating and providing a first bitstream block (St1)
a second non-deterministic random number generator (RNG2), preferably a quantum mechanical random number generator, for generating and providing a second bitstream block (St2),
a first computing device (G1) designed for calculating a first random number (Aₖ) from the bitstream block (St1) provided by the first random number generator (RNG1) and for generating a first time series ((Aₖ)) of random numbers by repeated calculation of first random numbers (Aₖ) from repeatedly provided first bitstream blocks (St1),
a second computing device (G2) designed for calculating a second random number (Bₖ) from the bitstream block (St2) provided by the second random number generator (RNG2) and for generating a second time series ((Bₖ)) of random numbers by repeated calculation of second random numbers (Bₖ) from repeatedly provided second bitstream blocks (St2),
characterized in that
the device additionally comprises a detection unit (D) for detecting a synchronicity range (SB) within the two time series, in that the detection unit (D) is designed to determine a starting point (j), so that the reduced first and second time series ((A_{k>=j}), (B_{k>=j})) with respect to a correlation measure (z1, z2, z3, z4) in a range (k₁, k₂), k₁, k₂>=j, k₁<k₂ exceeds a significance limit.

2. Device (1) according to claim 1, wherein the detection unit (D) is further designed to determine a correlation density (QRCD) for a synchronicity range (SB), which describes the synchronicity between the first and the second time series ((Aₖ), (Bₖ)) in the synchronicity range (SB).

3. Device (1) according to claim 1, wherein the device (1) comprises a plurality of pairs of random number generators (RNG1, RNG2), wherein the device (1) is designed such that two time series of random numbers ((Aₖ), (Bₖ)) are generated for each pair and the detection unit (D) is designed to determine synchronicity ranges (SB) and correlation measures (z1, z2, z3, z4) for each pair of time series ((Aₖ), (Bₖ)).

4. Device (1) according to claim 3, wherein the device additionally comprises a GPS sensor for localizing the pairs of non-deterministic random number generators (RNG1, RNG2).

5. Device (1) according to claim 4, wherein the detection unit (D) is further adapted to determine intersections of synchronicity ranges (SB) between the pairs.

6. Device (1) according to claim 1, wherein the device (1) comprises a clock generator (T) which causes the first and second non-deterministic random number generators (RNG1, RNG2) to generate the first and second bitstream blocks (St1, St2) and to provide them to the first and second computing device (G1, G2), which generate the first and second random numbers (Aₖ, Bₖ) therefrom, wherein the clock generator (T) generates a time stamp (tₖ) for each clock pulse and wherein the associated time stamp (tₖ) is saved for each first and second random number (Aₖ, Bₖ).

7. Device (1) according to claim 1, wherein the device additionally comprises an indicator unit (L) indicating whether the device is in a synchronicity range (SB).

8. The device (1) according to claim 7, wherein the indication varies according to the magnitude of the determined correlation measure (z1, z2, z3, z4) or, when referring back to claim 2, a determined correlation density (QRCD) in the synchronicity range (SB).

9. Method for identifying at least one synchronicity range (SB) of two time series of random numbers, a first time series (Aₖ) and a second time series (Bₖ), comprising the steps of
Repeatedly generating and providing a first bitstream block (St1) by means of a first non-deterministic random number generator (RNG1), preferably a quantum mechanical random number generator (QRNG1),
Repeated generation and provision of a second bitstream block (St2) by means of a second non-deterministic random number generator (RNG1), preferably a quantum mechanical random number generator (QRNG1),
Repeated calculation of a first random number (Aₖ) from the first bitstream block (St1) provided by means of a computing device (G, G1),
Repeated calculation of a second random number (Bₖ) from the second bitstream block (St2) provided by means of a computing device (G, G2),
Generate a first time series ((Aₖ)) of random numbers from the repeatedly calculated first random numbers (Aₖ),
Generate a second time series ((Bₖ)) of random numbers from the repeatedly calculated second random numbers (Bₖ),
characterized in that the method additionally comprises the following step
Detection of a synchronicity range (SB) within the two time series ((Aₖ), (Bₖ)) by means of a detection unit (D), if a starting point (j) can be determined, so that the reduced first and second time series ((A_{k>=j}), (B_{k>=j})) with respect to a correlation measure (z1, z2, z3, z4) in a range (k₁, k₂), k₁, k₂>=j, k₁<k₂ exceeds a significance limit.

10. The method according to claim 9, wherein the correlation measure (z1(k>=j), z2(k>=j), z3(k>=j)) is calculated based on random walks of the reduced first and second time series ((Aₖ), (Bₖ)) starting at the starting point (j).

11. Method according to claim 9, wherein the correlation measure (z1(k>=j), z2(k>=j), z3(k>=j)) is calculated based on Fourier-transformed random walks of the reduced first and second time series ((Ak), (Bk)) starting at the starting point (j).

12. Method according to claim 9, wherein for detecting a synchronicity range (SB) the two time series ((Aₖ), (Bₖ)) are shifted relative to each other, so that for each of the two time series ((Aₖ), (Bₖ)) a separate starting point (j1, j2) is determined and it is calculated whether the correlation measure (z1, z2, z3, z4) with respect to the shortened time series shifted relative to each other ((A_{k>=j1}), (B_{k>=j2})) exceeds a significance limit.

13. The method according to claim 9, wherein the correlation measure (z4) is calculated based on a linear correlation coefficient (r) of the reduced first and second time series ((Aₖ), (Bₖ)) starting at the starting point (j).

14. The method according to claim 9, wherein the correlation measure (z4) is calculated based on the entropy of the reduced first and second time series ((Ak), (Bk)) starting at the starting point (j).

15. The method according to claim 9, wherein a correlation density (QRCD) is determined from different correlation measures (z1, z2, z3, z4) by using the Stouffer method and/or the covariance.

16. Method according to claim 15, wherein methods with memory effect (channel1, channel2, channel3) and methods without memory effect (channel4) are taken into account as methods for calculating the correlation density (QRCD).

17. Method according to claim 15, wherein a noise correction is performed in the calculation of the correlation density (QRCD).

18. Method according to claim 9, wherein the method is carried out for a plurality of pairs of random number generators (RNG1, RNG2), so that two time series of random numbers ((Aₖ), (Bₖ)) are generated for each pair and synchronicity ranges (SB) and correlation measures (z1, z2, z3, z4) are determined for each pair of time series ((Aₖ), (Bₖ)).

19. Method according to claim 9, wherein the generation of the first and second random number (Aₖ, Bₖ) is triggered by a clock generator (T) which causes the first and second non-deterministic random number generators (RNG1, RNG2) to generate the first and second bitstream blocks (St1, St2), from which the first and second random numbers (Aₖ, Bₖ) are generated, wherein the clock generator (T) generates a time stamp (tₖ) for each clock pulse and wherein the associated time stamp (tₖ) is saved in the time series ((Aₖ(tₖ)), (Bₖ(tₖ)) for each first and second random number (Aₖ, Bₖ).

20. Use of the method according to claim 9 for searching for ordered structures in the first and second time series ((Aₖ), (Bₖ)).

21. Use of the method according to claim 9 for determining interpersonal and/or chorological synchronicities.

22. (canceled)

23. (canceled)
